(19) United States
(12) Patent Application Publication
(10) Pub. No.: US 2025/0316880 A1
(43) Pub. Date: Oct. 9, 2025

(54) LTCC MICROWAVE PASSIVE DEVICE

(71) Applicant: HUAWEI TECHNOLOGIES CO., LTD., Shenzhen (CN)

(72) Inventors: Qiaozhi SUN, Nanjing (CN); Wei WAN, Dongguan (CN); Minglang YU, Dongguan (CN); Xiaoliu ZHANG, Dongguan (CN)

(21) Appl. No.: 19/241,624

(22) Filed: Jun. 18, 2025

Related U.S. Application Data
(63) Continuation of application No. PCT/CN2023/138267, filed on Dec. 12, 2023.

(30) Foreign Application Priority Data
Dec. 20, 2022 (CN) 202211644638.X

(51) Int. Cl. H01P 5/18; H01P 5/19

(52) U.S. Cl. CPC H01P 5/184; H01P 5/19

(57) ABSTRACT

Embodiments of this application provide an LTCC microwave passive device. The LTCC microwave passive device includes a housing and a filter assembly. The housing includes a top portion, a bottom portion, and a side portion. The filter assembly is accommodated in the housing, and the filter assembly includes a first layer, a second layer, and a third layer. The first layer, the second layer, and the third layer are spaced apart sequentially in a direction from the top portion to the bottom portion, the first layer and the third layer are located on two opposite sides of the second layer respectively, the first layer includes at least two resonance units, each resonance unit includes a microstrip, the second layer includes a transfer busbar, and the microstrip of the resonance unit is connected to the transfer busbar through a corresponding first connection column and is grounded through the transfer busbar.

### CROSS-REFERENCE TO RELATED APPLICATIONS

This application is a continuation of International Application No. PCT/CN2023/138267, filed on Dec. 12, 2023, which claims priority to Chinese Patent Application No. 202211644638.X, filed on Dec. 20, 2022. The disclosures of the aforementioned applications are hereby incorporated by reference in their entireties.

### TECHNICAL FIELD

This application relates to the field of microwave technologies, and in particular, to an LTCC microwave passive device.

### BACKGROUND

A low-temperature co-fired ceramic (LTCC) technology is a mainstream technology for passive integration. Due to its unique advantages, the LTCC technology is widely applied to manufacture of microwave passive devices such as a coupler, a power splitter, a filter, a duplexer, and a combiner. For example, the LTCC technology can be used to manufacture a high-frequency filter. An internal circuit of the LTCC high-frequency filter uses a microstrip resonance coupling structure, and a grounding manner of an electrode inside the filter is usually microstrip side grounding. In other words, grounding connection is implemented through a side of a microstrip. However, there are a large quantity of grounded microstrips, a line width of the microstrips is small, the grounded microstrips are prone to breakage, and disconnection of any microstrip affects a resonance frequency of the microwave passive device, causing degradation in performance of the microwave passive device.

### SUMMARY

This application provides an LTCC microwave passive device. A transfer busbar is disposed between a plurality of microstrips that need to be grounded and a metal isolation plate, and the plurality of microstrips are grounded through the transfer busbar, to increase a grounding area and improve reliability of the LTCC microwave passive device.

A first aspect of embodiments of this application provides an LTCC microwave passive device, including: a housing, including a top portion, a bottom portion disposed opposite to the top portion, and a side portion located between the top portion and the bottom portion; and a filter assembly, accommodated in the housing and including a first layer, a second layer, and a third layer. The first layer, the second layer, and the third layer are spaced apart sequentially in a direction from the top portion to the bottom portion, the first layer and the third layer are located on two opposite sides of the second layer respectively, the first layer includes at least two resonance units, each resonance unit includes a microstrip, the second layer includes a transfer busbar, the third layer includes a first metal isolation plate, and the microstrip of the resonance unit is connected to the transfer busbar through a corresponding first connection column and is grounded through the transfer busbar. The first connection column and the resonance unit are the same in quantity and are in a one-to-one correspondence with each other.

According to the foregoing technical solution, a plurality of microstrips of the at least two resonance units are all connected to the transfer busbar through corresponding first connection columns and are grounded through the transfer busbar. In comparison with direct grounding through a microstrip, in this application, the transfer busbar is used to implement simultaneous grounding of the microstrips of the at least two resonance units, so that a grounding area is increased by at least two times, and reliability of the LTCC filter is improved.

Based on the first aspect, in an embodiment, the side portion includes a grounding port, the transfer busbar is connected to the first metal isolation plate through a second connection column, and the first metal isolation plate is in contact with the grounding port, to implement grounding.

According to the foregoing technical solution, the microstrips of the at least two resonance units in the first layer are connected to the transfer busbar through the first connection columns, the transfer busbar is connected to the first metal isolation plate through the second connection column, and the microstrips are grounded through the first metal isolation plate. It may be understood that, the microstrip is generally strip-shaped and has a small structure, and the first metal isolation plate is much larger than the microstrip in structure. Therefore, in comparison with a case in which a microstrip is in direct contact with the grounding port of the housing to implement grounding, in the technical solution of this application, the transfer busbar is connected to the first metal isolation plate, and the first metal isolation plate is in contact with the grounding port of the housing, to implement grounding, so that a grounding area is increased, and reliability is improved. In addition, in comparison with a case in which a plurality of microstrips are separately in point contact with a grounding port, the first metal isolation plate is in surface contact with the grounding port of the side portion, so that an area of contact is larger, and reliability is high.

Based on the first aspect, in an embodiment, the transfer busbar is in contact with the grounding port of the side portion of the housing, to implement grounding.

According to the foregoing technical solution, the transfer busbar is in contact with the grounding port of the housing, to implement grounding of the microstrip. In comparison with direct grounding of a microstrip, a grounding area is increased, and stability is improved.

Based on the first aspect, in an embodiment, the transfer busbar includes a transfer portion and at least two microstrip portions, the at least two microstrip portions are all connected to the transfer portion, the microstrip portion and the resonance unit are the same in quantity and are in a one-to-one correspondence with each other, the microstrip portion is used as a microstrip of the corresponding resonance unit, and the microstrip portion is connected to the corresponding resonance unit through the corresponding first connection column. In addition, in comparison with a case in which a plurality of microstrips are separately in point contact with a grounding port, the transfer busbar is in surface contact with the grounding port of the side portion, so that an area of contact is larger, and reliability is high.

According to the foregoing technical solution, the transfer portion and the at least two microstrip portions are in a same layer, and the transfer portion and the at least two microstrip portions may be manufactured by using one process, so that process steps are reduced, costs are reduced, and efficiency is improved.

Based on the first aspect, in an embodiment, a quantity of first connection columns is greater than a quantity of second connection columns.

According to the foregoing technical solution, the quantity of second connection columns is reduced, and the second connection column is connected to the first metal isolation plate, so that a silver coverage rate of the first metal isolation plate can be reduced.

Based on the first aspect, in an embodiment, there are at least two second connection columns.

According to the foregoing technical solution, the at least two second connection columns are used to improve stability of connection between the first metal isolation plate and the transfer busbar.

Based on the first aspect, in an embodiment, there are at least two microstrips in each resonance unit, the at least two microstrips are disposed sequentially in the direction from the top portion to the bottom portion, and the at least two microstrips are all connected to the corresponding first connection column.

According to the foregoing technical solution, the at least two microstrips are all connected through the first connection column. In this way, microstrips that need to be grounded in each resonance unit may be all grounded through the transfer busbar.

Based on the first aspect, in an embodiment, surfaces of the at least two microstrips of each resonance unit are parallel to each other and are perpendicular to an extension direction of the first connection column.

According to the foregoing technical solution, the extension direction of the first connection column is perpendicular to the surfaces of the at least two microstrips, to reduce a length of the first connection column.

Based on the first aspect, in an embodiment, the side portion includes the grounding port, and each microstrip is in contact with the grounding port.

According to the foregoing technical solution, when the transfer busbar is connected to the grounding port of the side portion to implement grounding, and/or the transfer busbar is connected to the first metal isolation plate through the second connection column and the first metal isolation plate is in contact with the grounding port to implement grounding, the microstrip is then in contact with the grounding port to implement grounding, to improve reliability of the LTCC microwave passive device.

Based on the first aspect, in an embodiment, the filter assembly further includes a fourth layer, the fourth layer is located on a side that is of the first layer and that is away from the second layer, the fourth layer includes a second metal isolation plate, and the at least two resonance units and the transfer busbar are located between the second metal isolation plate and the first metal isolation plate.

According to the foregoing technical solution, the first metal isolation plate cooperates with the second metal isolation plate to provide an isolation environment.

### BRIEF DESCRIPTION OF DRAWINGS

FIG. 1 is a diagram of a structure of an LTCC filter according to an embodiment of this application;

FIG. 2 is an exploded diagram of the LTCC filter shown in FIG. 1;

FIG. 3 is an exploded diagram of a filter assembly shown in FIG. 2;

FIG. 4 is an exploded diagram of a first layer shown in FIG. 1;

FIG. 5 is a curve diagram of an S parameter of the LTCC filter shown in FIG. 1;

FIG. 6 is another exploded diagram of the LTCC filter shown in FIG. 1;

FIG. 7 is an exploded diagram of a filter assembly shown in FIG. 6;

FIG. 8 is another exploded diagram of the LTCC filter shown in FIG. 1; and

FIG. 9 is an exploded diagram of a filter assembly shown in FIG. 8.

DESCRIPTION OF REFERENCE NUMERALS
FOR MAIN COMPONENTS

| | |
|---|---|
| LTCC filter | 100 |
| Housing | 10 |
| Top portion | 12 |
| Bottom portion | 14 |
| Side portion | 16 |
| Input port | 162 |
| Output port | 164 |
| Grounding port | 166 |
| Filter assembly | 20 |
| First layer | 22 |
| Resonance unit | 222 |
| Microstrip | 2222 |
| Through hole | 2223 |
| Conductor | 2224 |
| First part | 2225 |
| Second part | 2226 |
| Connection portion | 2227 |
| Second layer | 24 |
| Transfer busbar | 242 |
| Transfer portion | 2422 |
| Microstrip portion | 2424 |
| Second grounding end | 2426 |
| Third layer | 26 |
| First metal isolation plate | 262 |
| First grounding end | 2622 |
| First connection column | 20a |
| Top end | 21a |
| Bottom end | 22a |
| Second connection column | 20b |
| Fourth layer | 28 |
| Second metal isolation plate | 282 |

In the following embodiments, this application is further described with reference to the accompanying drawings.

### DESCRIPTION OF EMBODIMENTS

The following describes embodiments of this application by using specific embodiments. A person skilled in the art may easily learn of other advantages and effects of this application based on content disclosed in this specification. Although descriptions of this application are provided with reference to example embodiments, this does not mean that features of this application are limited to this embodiment. On the contrary, a purpose of describing this application with reference to an embodiment is to cover another option or modification that may be derived based on claims of this application. To provide an in-depth understanding of this application, the following descriptions include a plurality of specific details. This application may alternatively be implemented without using these details. In addition, to avoid confusion or blurring a focus of this application, some specific details are omitted from the descriptions. It should be noted that embodiments of this application and features in embodiments may be mutually combined in the case of no conflict.

The following terms “first”, “second”, and the like are merely used for description, and shall not be understood as an indication or implication of relative importance or implicit indication of a quantity of indicated technical features. Therefore, a feature defined by “first”, “second”, or the like may explicitly or implicitly include one or more features. In the descriptions of this application, unless otherwise stated, “a plurality of” means two or more than two. Orientation terms such as “upper”, “lower”, “left”, and “right” are defined relative to an orientation of schematic placement of components in accompanying drawings. It should be understood that these directional terms are relative concepts and are used for relative description and clarification. These directional terms may vary accordingly depending on an orientation in which the components are placed in the accompanying drawings.

In this application, unless otherwise clearly specified and limited, the term “connection” should be understood in a broad sense. For example, the “connection” may be fixed connection, detachable connection, or integrated connection, or may be direct connection or indirect connection through an intermediate medium. The term “and/or” used in this specification includes any and all combinations of one or more related listed items.

When the following embodiments are described in detail with reference to diagrams, for ease of description, a diagram indicating a partial structure of a component is partially enlarged not based on a general scale. In addition, the diagrams are merely examples, and shall not limit the protection scope of this application herein.

To make objectives, technical solutions, and advantages of this application clearer, the following further describes the embodiments of this application in detail with reference to the accompanying drawings.

It may be understood that an LTCC microwave passive device is a microwave device manufactured by using an LTCC technology. The LTCC microwave passive device in embodiments of this application may be a filter, a coupler, a duplexer, or the like.

The LTCC microwave passive device in embodiments of this application may be used in a radio frequency front-end link of a wireless local area network (WLAN), an optical network terminal (ONT), a wireless mobile network, a terminal, a base station, or the like, to play a filtering role.

For ease of understanding, the following embodiments of this application are described by using an example in which the LTCC microwave passive device is a filter.

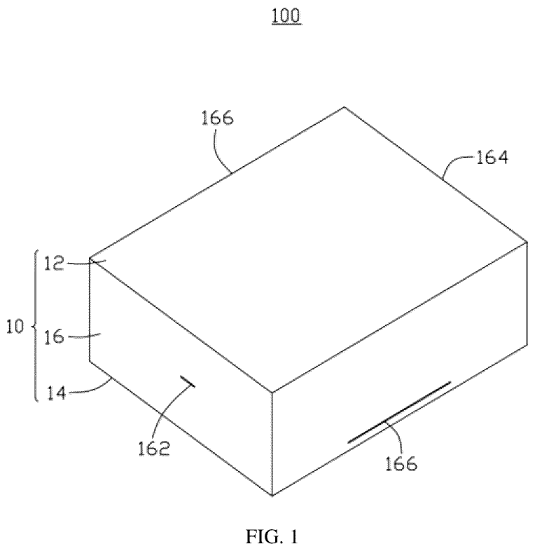

FIG. 1 is a diagram of a structure of an LTCC filter 100 according to an embodiment of this application. As shown in FIG. 1, the LTCC filter 100 includes a housing 10. The housing 10 includes a top portion 12, a bottom portion 14, and a side portion 16. The top portion 12 and the bottom portion 14 are disposed opposite to each other, the side portion 16 is located between the top portion 12 and the bottom portion 14, and the top portion 12, the side portion 16, and the bottom portion 14 enclose a closed space. The side portion 16 in FIG. 1 includes an input port 162, an output port 164, and two grounding ports 166. The input port 162 and the output port are disposed opposite to each other, and the two grounding ports 166 are disposed opposite to each other. It may be understood that, in another embodiment, there may be one grounding port 166 or more than two grounding ports 166, and the grounding ports 166 may be disposed opposite to each other in pairs, or may be disposed in another manner.

The housing 10 in FIG. 1 is a cuboid. A surface of the top portion 12 and a surface of the bottom portion 14 are both rectangular and are parallel to each other. The side portion 16 is formed by sequentially connecting four rectangles. The input port 162, the output port 164, and the two grounding ports 166 are separately located in a corresponding rectangle. A surface of the side portion 16 is perpendicular to both the surface of the top portion 12 and the surface of the bottom portion 14. It may be understood that, in another embodiment, the housing 10 may be in another shape, for example, a square or a frustum.

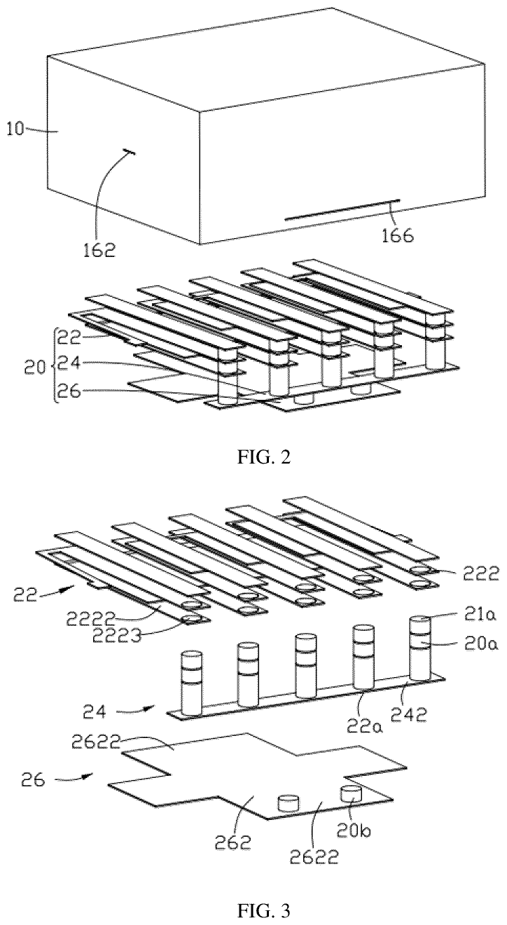

As shown in FIG. 2, FIG. 2 is an exploded diagram of the LTCC filter 100 shown in FIG. 1. The LTCC filter 100 further includes a filter assembly 20, and the filter assembly 20 is accommodated in the housing 10.

The filter assembly 20 includes a first layer 22, a second layer 24, and a third layer 26. The first layer 22, the second layer 24, and the third layer 26 are spaced apart sequentially in a direction from the top portion 12 to the bottom portion 14. The first layer 22 and the third layer 26 are located on two opposite sides of the second layer 24 respectively.

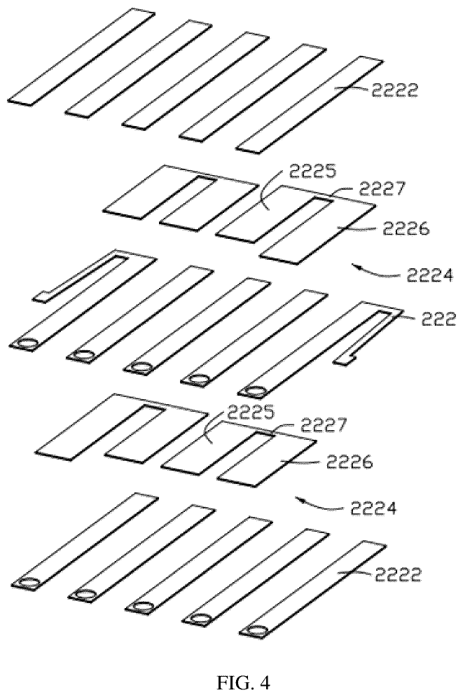

FIG. 3 is an exploded diagram of the filter assembly 20 shown in FIG. 2. The first layer 22 includes at least two resonance units 222, the second layer 24 includes a transfer busbar 242, the third layer 26 includes a first metal isolation plate 262, each resonance unit 222 includes a microstrip 2222, and the microstrip 2222 is connected to the transfer busbar 242 through a first connection column 20a.

In this way, a plurality of microstrips 2222 of the at least two resonance units 222 are all connected to the transfer busbar 242 through corresponding first connection columns 20a and are grounded through the transfer busbar 242. In comparison with direct grounding through a side surface of a microstrip 2222, in this application, the transfer busbar 242 is used to implement simultaneous grounding of the microstrips 2222 of the at least two resonance units 222, so that a quantity of microstrips 2222 that are grounded through a side is reduced, a grounding area is increased, and reliability of the LTCC filter 100 is improved. Herein, grounding implemented through the transfer busbar 242 may indicate direct contact with the grounding port 166 through the transfer busbar 242, or may indicate that the transfer busbar 242 is in contact with the grounding port 166 through another structure.

In some embodiments, the transfer busbar 242 is located on a strip electrode in the second layer 24, and the strip electrode is connected to the microstrips 2222 of the at least two resonance units 222 through the first connection columns 20a.

In some embodiments, there are at least two microstrips 2222 in each resonance unit 222, the at least two microstrips 2222 are disposed sequentially in the direction from the top portion 12 to the bottom portion 14, and the at least two microstrips 2222 are all connected to the first connection column 20a. In other words, the at least two microstrips 2222 are connected to the transfer busbar 242 through the first connection column 20a. In this way, the at least two microstrips 2222 of each resonance unit 222 are all grounded through the transfer busbar 242, to increase a grounding area and improve stability of the LTCC filter 100.

In some embodiments, surfaces of the at least two microstrips 2222 of each resonance unit 222 are parallel to each other and are all perpendicular to an extension direction of the first connection column 20a. In this way, the at least two microstrips 2222 are connected through the first connection column 20a that is perpendicular to extension directions of the at least two microstrips 2222, to ensure that the at least two microstrips 2222 can be connected through the first connection column 20a with a small extension length.

In some embodiments, the first connection column 20a is located between an upper microstrip and the transfer busbar 242, the first connection column 20a has a top end 21a and a bottom end 22a that are disposed opposite to each other, the top end 21a is an end of the first connection column 20a close to the top portion 12, the bottom end 22a is an end of the first connection column 20a close to the bottom portion 14, the top end 21a of the first connection column 20a is connected to a surface that is of the upper microstrip and that faces the bottom portion 14, and the bottom end 22a of the first connection column 20a is connected to a surface that is of the transfer busbar 242 and that faces the top portion 12. In addition, the first connection column 20a runs through another microstrip 2222 between the upper microstrip and the transfer busbar 242 through a through hole 2223. The upper microstrip is a microstrip close to the top portion 12 in the at least two microstrips 2222 of each resonance unit 222.

Refer to FIG. 3. There are five resonance units 222 in the first layer 22 in FIG. 3, there are three microstrips 2222 that need to be grounded in each resonance unit 222, and the three microstrips 2222 are all connected to the corresponding first connection column 20a and are connected to the transfer busbar 242 through the first connection column 20a.

It may be understood that, in another embodiment, both a quantity of resonance units 222 and a quantity of microstrips 2222 in each resonance unit 222 may be set according to an actual requirement.

Further, in the technical solution of this application, the transfer busbar 242 is added to the LTCC filter 100, and the plurality of microstrips 2222 of the plurality of resonance units 222 are grounded through the transfer busbar 242. In addition, in an actual application, a structure or a size of the transfer busbar 242 may be adjusted according to an actual requirement, to adjust inductance or capacitance of the transfer busbar 242, to adjust a frequency of the LTCC filter 100.

Refer to FIG. 3. The third layer 26 includes the first metal isolation plate 262. The transfer busbar 242 is connected to the first metal isolation plate 262 through a second connection column 20b, and the first metal isolation plate 262 is in contact with the grounding port 166 of the housing 10, to implement grounding.

In this way, the microstrips 2222 of the at least two resonance units 222 in the first layer 22 are connected to the transfer busbar 242 through the first connection columns 20a, the transfer busbar 242 is connected to the first metal isolation plate 262 through the second connection column 20b, and the microstrips 2222 are grounded through the first metal isolation plate 262. It may be understood that, the microstrip 2222 is generally strip-shaped and has a small structure, and the first metal isolation plate 262 is much larger than the microstrip 2222 in structure. Therefore, in comparison with a case in which a microstrip 2222 is in direct contact with the grounding port 166 of the side portion 16 of the housing 10 to implement grounding, in the technical solution of this application, the transfer busbar 242 is connected to the first metal isolation plate 262, and the first metal isolation plate 262 is in contact with the housing 10, to implement grounding, so that a grounding area is increased, and reliability is improved.

Refer to FIG. 3. A side of the first metal isolation plate 262 is in contact with the grounding port 166 of the side portion 16, to implement grounding.

Specifically, the first metal isolation plate 262 has at least one first grounding end 2622, and the first grounding end 2622 is in contact with the grounding port 166 of the side portion 16, to implement grounding.

The first metal isolation plate 262 in FIG. 3 is plate-shaped and has two first grounding ends 2622 that are disposed opposite to each other, and the first grounding ends 2622 are strip-shaped, to increase an area of contact with the grounding port 166 of the side portion 16 of the housing 10.

In some embodiments, each resonance unit 222 corresponds to one first connection column 20a, and a quantity of first connection columns 20a is greater than a quantity of second connection columns 20b. A relationship between the quantity of first connection columns 20a and the quantity of second connection columns 20b is limited, to reduce a quantity of second connection columns 20b connected to the first metal isolation plate 262, to reduce a silver coverage rate of the first metal isolation plate 262. This can avoid layer cracking and warping caused by thermal stress between a silver layer and ceramic in the LTCC filter 100 due to an excessively large silver coverage area on the first metal isolation plate 262, to avoid impact on a yield of the LTCC filter 100.

In some embodiments, extension directions of the first connection column 20a and the second connection column 20b are parallel to each other, and surfaces of the first metal isolation plate 262 and the transfer busbar 242 are parallel to each other and are all perpendicular to the extension directions of the first connection column 20a and the second connection column 20b.

In some embodiments, there are at least two second connection columns 20b, and the at least two second connection columns 20b ensure stability of connection between the transfer busbar 242 and the first metal isolation plate 262. In another embodiment, there may be one second connection column 20b, provided that the transfer busbar 242 can be connected to the first metal isolation plate 262 through the second connection column 20b.

FIG. 4 is an exploded diagram of the first layer 22. The first layer 22 includes at least two resonance units 222, and each resonance unit 222 includes at least two microstrips 2222.

A conductor 2224 is further disposed between two microstrips 2222 of each resonance unit 222, and the conductor 2224 includes a first part 2225 and a second part 2226 that are disposed in parallel, and a connection portion 2227 that connects the first part 2225 to the second part 2226. The microstrips 2222 are coupled to the conductor 2224 to form the resonance unit 222. Extension directions of the first part 2225, the second part 2226, and a corresponding microstrip 2222 are the same and are perpendicular to an extension direction of the connection portion 2227.

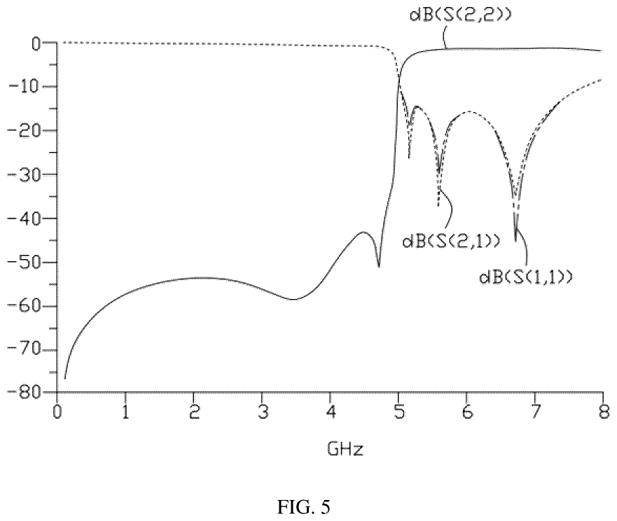

FIG. 5 is a curve diagram of an S parameter of the LTCC filter 100 shown in FIG. 1. It can be learned from FIG. 5 that a passband range of the LTCC filter 100 is 5150 MHz to 7125 MHz, an in-passband insertion loss S(2,1) is less than 5.5 dB, a standing wave ratio is less than 2.3, a stopband loss in the range of 30 MHz to 4800 MHz is 25 dB, and a stopband loss in the range of 4800 MHZ to 4900 MHz is 20 dB. Stopband suppression performance is excellent, a passband insertion loss is small, and filtering performance is good.

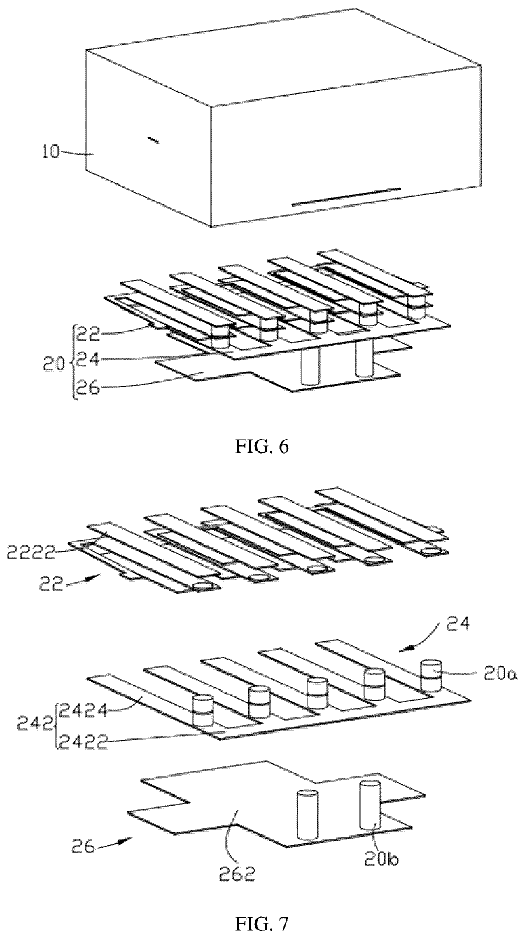

FIG. 6 is another exploded diagram of the LTCC filter 100 shown in FIG. 1 according to an embodiment of this application. FIG. 7 is an exploded diagram of a filter assembly 20 shown in FIG. 6. The LTCC filter 100 includes a housing 10 and the filter assembly 20. The filter assembly 20 shown in FIG. 6 includes a first layer 22, a second layer 24, and a third layer 26. The first layer 22 shown in FIG. 7 includes at least two resonance units 222, each resonance unit 222 includes at least two microstrips 2222, the second layer 24 includes a transfer busbar 242, the at least two microstrips 2222 of each resonance unit 222 are connected to the transfer busbar 242 through a corresponding first connection column 20a, the third layer 26 includes a first metal isolation plate 262, and the first metal isolation plate 262 is connected to the transfer busbar 242 through a second connection column 20b. A connection relationship between layers and structures of the layers are similar to those in the LTCC filter 100 in FIG. 2, and are not described herein again. A difference is as follows.

The transfer busbar 242 includes a transfer portion 2422 and at least two microstrip portions 2424, the at least two microstrip portions 2424 are all connected to the transfer portion 2422, the microstrip portion 2424 and the resonance unit 222 are the same in quantity and are in a one-to-one correspondence with each other, and each microstrip portion 2424 is used as a microstrip of the corresponding resonance unit 222. Each microstrip portion 2424 is connected to another microstrip 2222 through the corresponding first connection column 20a.

In this way, microstrips that are of the at least two resonance units 222 and that are in the second layer 24 (namely, the microstrip portions 2424) are integrated with the transfer busbar 242 (namely, the transfer portion 2422). The integrated structure may implement a function of the microstrips 2222, and may also implement a function of the transfer busbar 242. In this way, the microstrips 2222 and the transfer busbar 242 may be manufactured by using one process, for example, manufactured by using only one inner electrode pattern printing process, so that process steps are reduced, and costs and process complexity are reduced.

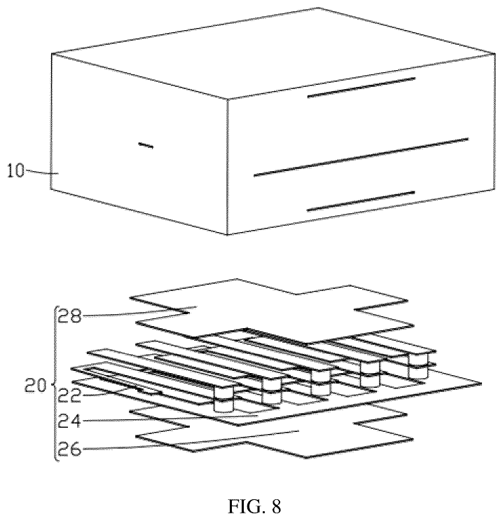

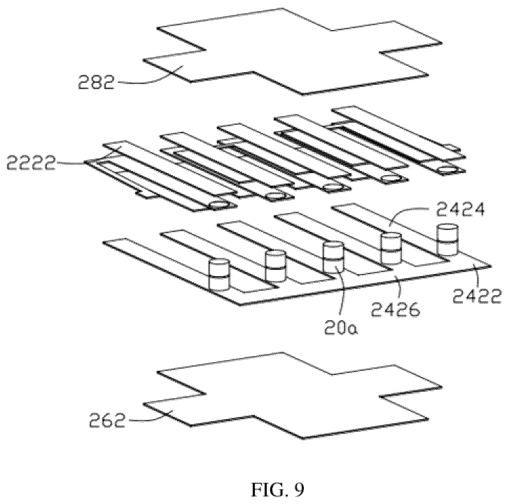

FIG. 8 is another exploded diagram of the LTCC filter 100 according to an embodiment of this application. FIG. 9 is an exploded diagram of a filter assembly 20 shown in FIG. 8. The LTCC filter 100 includes a housing 10 and the filter assembly 20. The filter assembly 20 shown in FIG. 8 includes a first layer 22, a second layer 24, and a third layer 26. The first layer 22 shown in FIG. 9 includes at least two resonance units 222, each resonance unit 222 includes at least two microstrips 2222, the second layer 24 includes a transfer busbar 242, the at least two microstrips 2222 of each resonance unit 222 are connected to the transfer busbar 242 through a corresponding first connection column 20a, the third layer 26 includes a first metal isolation plate 262, and the first metal isolation plate 262 and the transfer busbar 242 are spaced apart. A connection relationship between layers and structures of the layers are similar to those in the LTCC filter 100 in FIG. 2, and are not described herein again. A difference is as follows.

The transfer busbar 242 in FIG. 9 extends toward a side portion 16 and is in contact with a grounding port 166 of the side portion 16, to implement grounding. Compared with a microstrip 2222 that is directly grounded, the microstrip 2222 in FIG. 9 is grounded through the transfer busbar 242, to reduce a quantity of microstrips that are grounded singly, so that a grounding area is increased, and reliability is improved. In addition, in FIG. 9, no second connection column 20b is disposed between the transfer busbar 242 and the first metal isolation plate 262.

Further, a second grounding end 2426 is disposed on a side that is of the transfer busbar 242 and that is close to the side portion 16, and the transfer busbar 242 is in contact with the grounding port 166 of the side portion 16 through the second grounding end 2426, to implement grounding.

In some embodiments, the filter assembly 20 further includes a fourth layer 28, the fourth layer 28 is located on a side that is of the first layer 22 and that is away from the second layer 24, the fourth layer 28 includes a second metal isolation plate 282, the at least two resonance units 222 and the transfer busbar 242 are located between the second metal isolation plate 282 and the first metal isolation plate 262, and the second metal isolation plate 282 cooperates with the first metal isolation plate 262 to provide a shielding environment.

It may be understood that, in another embodiment, a second connection column 20b is disposed between the transfer busbar 242 and the first metal isolation plate 262. The second connection column 20b is connected to the first metal isolation plate 262, and the first metal isolation plate 262 is in contact with the grounding port 166, to implement grounding. In this way, the microstrip 2222 is in contact with the grounding port 166 of the side portion 16 through the transfer busbar 242 to implement grounding, and is also in contact with the grounding port 166 of the side portion 16 of the housing 10 through the first metal isolation plate 262 to implement grounding. The two grounding manners are combined, to increase a grounding area and improve reliability.

It may be understood that, in another embodiment, the at least two microstrips 2222 of the resonance unit 222 are all connected to the grounding port 166 of the side portion 16, to implement grounding. When the transfer busbar 242 is connected to the grounding port 166 of the side portion 16 to implement grounding, and/or the transfer busbar 242 is connected to the first metal isolation plate 262 through the second connection column 20b and the first metal isolation plate 262 is in contact with the grounding port 166 to implement grounding, the microstrip 2222 is then in contact with the grounding port 166 to implement grounding, to improve reliability of the LTCC filter 100.

In some embodiments, the side portion 16 has a plurality of grounding ports 166. In this case, a plurality of microstrips 2222 may be in direct contact with the grounding port 166, to implement grounding; or a plurality of microstrips 2222 may be connected to the transfer busbar 242 through the first connection column 20a, and the transfer busbar 242 is in contact with the grounding port 166, to implement grounding; or a plurality of microstrips 2222 may be connected to the transfer busbar 242 through the first connection column 20a, the transfer busbar 242 is connected to the first metal isolation plate 262 through the second connection column 20b, and the first metal isolation plate 262 is in contact with the grounding port 166, to implement grounding. In a combination of at least two of the foregoing three solutions, the microstrip 2222, the transfer busbar 242, and the first metal isolation plate 262 may all be in contact with a corresponding grounding port 166, to implement grounding.

It may be understood that the input port 162, the output port 164, the grounding port 166, the first metal isolation plate 262, the second metal isolation plate 282, and the resonance unit 222 in the LTCC filter 100 shown in FIG. 1, FIG. 2, FIG. 3, FIG. 4, FIG. 6, FIG. 7, FIG. 8, and FIG. 9 are all implemented by using a material such as metal silver, gold, or copper, and an implementation process is a multi-layer low-temperature co-fired ceramic technology.

The foregoing descriptions are merely embodiments of this application, but are not intended to limit the protection scope of this application. Any variation or replacement within the technical scope disclosed in this application shall fall within the disclosure scope of this application.

1. An LTCC microwave passive device, comprising:
a housing, comprising a top portion, a bottom portion disposed opposite to the top portion, and a side portion located between the top portion and the bottom portion; and
a filter assembly, accommodated in the housing and comprising a first layer, a second layer, and a third layer, wherein the first layer, the second layer, and the third layer are spaced apart sequentially in a direction from the top portion to the bottom portion, the first layer and the third layer are located on two opposite sides of the second layer respectively, the first layer comprises at least two resonance units, each resonance unit comprises a microstrip, the second layer comprises a transfer busbar, the third layer comprises a first metal isolation plate, and the microstrip of the resonance unit is connected to the transfer busbar through a corresponding first connection column and is grounded through the transfer busbar, wherein
the first connection column and the resonance unit are the same in quantity and are in a one-to-one correspondence with each other.

2. The LTCC microwave passive device according to claim 1, wherein the side portion comprises a grounding port, the transfer busbar is connected to the first metal isolation plate through a second connection column, and the first metal isolation plate is in contact with the grounding port, to implement grounding.

3. The LTCC microwave passive device according to claim 1, wherein the side portion comprises the grounding port, and the transfer busbar is in contact with the grounding port, to implement grounding.

4. The LTCC microwave passive device according to claim 1, wherein the transfer busbar comprises a transfer portion and at least two microstrip portions, the at least two microstrip portions are all connected to the transfer portion, the microstrip portion and the resonance unit are the same in quantity and are in a one-to-one correspondence with each other, the microstrip portion is used as a microstrip of the corresponding resonance unit, and the microstrip portion is connected to the corresponding resonance unit through the corresponding first connection column.

5. The LTCC microwave passive device according to claim 1, wherein a quantity of first connection columns is greater than a quantity of second connection columns.

6. The LTCC microwave passive device according to claim 5, wherein there are at least two second connection columns.

7. The LTCC microwave passive device according to claim 1, wherein there are at least two microstrips in each resonance unit, the at least two microstrips are disposed sequentially in the direction from the top portion to the bottom portion, and the at least two microstrips are all connected to the corresponding first connection column.

8. The LTCC microwave passive device according to claim 7, wherein surfaces of the at least two microstrips of each resonance unit are parallel to each other and are perpendicular to an extension direction of the first connection column.

9. The LTCC microwave passive device according to claim 1, wherein the side portion comprises the grounding port, and each microstrip is in contact with the grounding port.

10. The LTCC microwave passive device according to claim 1, wherein the filter assembly further comprises a fourth layer, the fourth layer is located on a side that is of the first layer and that is away from the second layer, the fourth layer comprises a second metal isolation plate, and the at least two resonance units and the transfer busbar are located between the second metal isolation plate and the first metal isolation plate.
